(19) United States
(12) Patent Application Publication
(10) Pub. No.: US 2020/0189639 A1
(43) Pub. Date: Jun. 18, 2020

(54) INTERCHANGEABLE MOTORIZED UTILITY VEHICLE ASSEMBLY

(71) Applicants: KEITH KEORAJ, ZIMMERMAN, MN (US); NEIL GRITTNER, ROGERS, MN (US)

(72) Inventors: KEITH KEORAJ, ZIMMERMAN, MN (US); NEIL GRITTNER, ROGERS, MN (US)

(21) Appl. No.: 16/719,966

(22) Filed: Dec. 18, 2019

Related U.S. Application Data
(60) Provisional application No. 62/781,294, filed on Dec. 18, 2018.

(51) Int. Cl. B62B 5/00; B62B 1/18; B60K 1/04

(52) U.S. Cl. CPC B62B 5/0046; B60L 50/60; B60K 1/04; B62B 1/18

(57) ABSTRACT

A motorized wheelbarrow assembly, the assembly comprising a unitary frame comprising a base portion and a handle system, the base portion having a first end region and a second end region, the handle system extending from the first end region of the base portion of the frame, a bucket coupled to the base portion of the frame, a drive mechanism coupled to a bottom surface of the base portion of the frame, a first rotatable rear wheel and a second rotatable rear wheel coupled to the first end region of the base portion of the frame, and a first front wheel and a second front wheel coupled to the second end region of the base portion of the frame and to the drive mechanism, wherein the first front wheel and the second front wheel are driven by the drive mechanism.

### CROSS-REFERENCE TO RELATED APPLICATIONS

This application claims the benefit of priority under 35 U.S.C. § 119 to U.S. Provisional Application Ser. No. 62/781,294, filed Dec. 18, 2018, the entirety of which is incorporated herein by reference.

### TECHNICAL FIELD

The present disclosure pertains to interchangeable motorized utility vehicle assemblies, including wheelbarrows. More particularly, the present disclosure pertains to motorized wheelbarrow assemblies.

### BACKGROUND

There is an ongoing need to provide improved motorized wheelbarrows that improved maneuverability, higher payload, higher torque, improved ease of use, and so forth.

### BRIEF SUMMARY

This disclosure provides design, material, manufacturing method, and use alternatives for interchangeable motorized utility vehicle assemblies, in particular, wheelbarrows.

In one aspect, the present disclosure relates to a motorized wheelbarrow assembly, the assembly comprising a unitary frame comprising a base portion and a handle system, the base portion having a first end region and a second end region, the handle system extending from the first end region of the base portion of the frame, a bucket coupled to the base portion of the frame, a drive mechanism coupled to a bottom surface of the base portion of the frame, a first rotatable rear wheel and a second rotatable rear wheel coupled to the first end region of the base portion of the frame, and a first front wheel and a second front wheel coupled to the second end region of the base portion of the frame and to the drive mechanism, wherein the first front wheel and the second front wheel are driven by the drive mechanism.

Alternatively or additionally to any of the embodiments above, the first rotatable rear wheel, the second rotatable rear wheel, or both are designed to both rotate and swivel.

Alternatively or additionally to any of the embodiments above, the bucket comprises stainless steel.

Alternatively or additionally to any of the embodiments above, the bucket comprises a front planar side intersecting at an angle to a first planar side and to a second planar side.

Alternatively or additionally to any of the embodiments above, the handle system comprises a first handle member and a second handle member.

Alternatively or additionally to any of the embodiments above, a first portion of the handle system, a second portion of the handle system, or both, extend above a base portion of the frame.

Alternatively or additionally to any of the embodiments above, a bottom surface of the bucket comprises a mounting region having an opening, the opening of the mounting region is designed for receiving a connecting member coupled to the base portion of the frame.

Alternatively or additionally to any of the embodiments above, the opening of the mounting region forms an interference fit with the connecting member.

Alternatively or additionally to any of the embodiments above, the mounting region further comprises a fastener for securing the connecting member thereto.

Alternatively or additionally to any of the embodiments above, the mounting region further comprises a locking system for securing the connecting member thereto.

Alternatively or additionally to any of the embodiments above, an integrated braking system is coupled to one or more of the wheels, to the handle system, or both.

Alternatively or additionally to any of the embodiments above, an integrated throttle system is coupled to the drive mechanism, the handle system, or both.

Alternatively or additionally to any of the embodiments above, the drive mechanism comprises a gas engine.

Alternatively or additionally to any of the embodiments above, the drive mechanism comprises a high torque gearbox and drive system.

Alternatively or additionally to any of the embodiments above, the first front wheel, the second front wheel, the first rotatable rear wheel, the second rotatable rear wheel, or a combination thereof comprises a pneumatic tire.

Alternatively or additionally to any of the embodiments above, the frame comprises stainless steel square tubing.

In another aspect, the present disclosure relates to a motorized wheelbarrow assembly, the assembly comprising a unitary frame comprising a base portion, the base portion having a first end region and a second end region, and a handle extending from the first end region of the base portion of the frame, a bucket coupled to the base portion of the frame, a drive mechanism coupled to the base portion of the frame, a first set of one or more wheels coupled to the first end region of the base portion of the frame, and a second set of one or more wheels coupled to the second end region of the base portion of the frame and to the drive mechanism, wherein the second set of one or more wheels are designed to be driven by the drive mechanism.

Alternatively or additionally to any of the embodiments above, the first set of one or more wheels comprises two rotatable caster wheels, the two rotatable caster wheels are coupled to the first end region of the base portion of the frame.

Alternatively or additionally to any of the embodiments above, the second set of one or more wheels are coupled to the second end region of the base portion of the frame, the second set of one or more wheels are rotatable about an axle, the axle is fixed horizontally to the base portion of the frame.

In another aspect, the present disclosure relates to a motorized wheelbarrow assembly, the assembly comprising a unitary frame comprising a base portion, the base portion having a first end region and a second end region, and a handle extending from the first end region of the base portion of the frame, a bucket having a seamless interior, the bucket is coupled to the base portion of the frame with an external mounting system, the external mounting system comprising a first portion coupled to a bottom surface of the bucket and a second portion coupled to the base portion of the frame, a drive mechanism coupled to the base portion of the frame, a first rotatable caster wheel and a second rotatable caster wheel coupled to the first end region of the base portion of the frame, and a first front wheel and a second front wheel coupled to the second end region of the base portion of the frame and to the drive mechanism, wherein the first front wheel and the second front wheel are driven by the drive mechanism.

Alternatively or additionally to any of the embodiments above, the motorized wheelbarrow assembly may be an interchangeable motorized wheelbarrow assembly, wherein the bucket may be replaced by a single layer planar structure, a multilayer planar structure, an extendable planar structure, or a structure having a planar bottom and first and second parallel sides and first and second parallel ends.

In another aspect, the present disclosure related to a motorized wheelbarrow assembly, the assembly comprising a unitary frame comprising a base portion, the base portion having a first end region and a second end region, and a handle extending from the first end region of the base portion of the frame, a bucket removably coupled to the base portion of the frame, a drive mechanism coupled to the base portion of the frame, a first set of one or more wheels coupled to the first end region of the base portion of the frame and a second set of one or more wheels coupled to the second end region of the base portion of the frame and to the drive mechanism, wherein the second set of one or more wheels are designed to be driven by the drive mechanism.

Alternatively or additionally to any of the embodiments above, the bucket is replaceable with a single layer planar structure, a multilayer planar structure, an extendable planar structure, or a structure having a planar bottom and first and second parallel sides and first and second parallel ends

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a side view of an example motorized wheelbarrow;

FIG. 2 is a front view of an example motorized wheelbarrow;

FIG. 3 is a top down view of a portion of an example wheelbarrow with rotating and swiveling rear wheels;

FIG. 4 is a top down view of an example motorized wheelbarrow;

FIG. 5 is a top down view of an example frame for a wheelbarrow;

FIG. 6 is a side view of an example bucket for a wheelbarrow with fasteners for securement to a frame; and

FIG. 7 is a partial view of an example wheelbarrow with an example mounting region and fastener for securement to connecting member on the frame.

### DETAILED DESCRIPTION

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

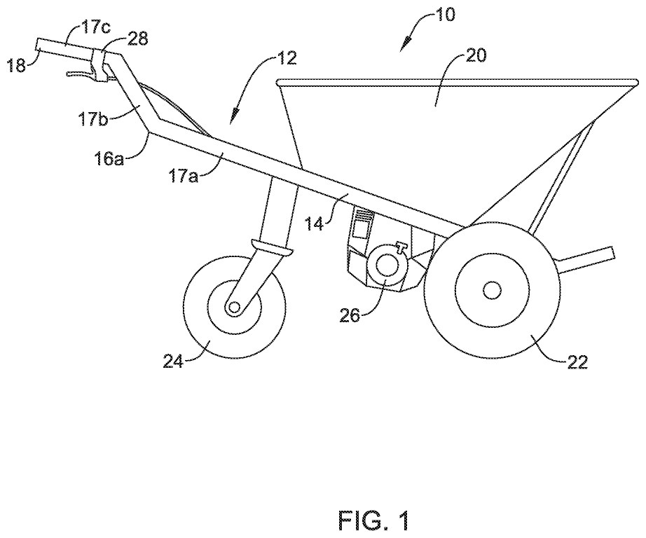

FIG. 1 is a side view of an exemplary motorized wheelbarrow 10. Wheelbarrow 10 includes a bucket or tub 20 and a unitary frame 12. For the purposes of this disclosure, a “unitary” frame 12 may be understood to be a frame constructed from a singular piece of material that formed into the desired shape/configuration as opposed to multiple components that are secured together. Frame 12 includes a base portion 14, and at least one handle system 16a. The bucket 20 is coupled to an upper surface of the base portion 14 of the frame 12. The bucket 20, in general, is designed to carry cargo in a manner consistent with the typical uses of a wheelbarrow.

The bucket 20, is removable, and may be interchanged with alternative structures. For example, bucket 20 may be replaced with, including but not limited to, single or multilayer level or planar material carrying carts, level or planar extended or extendable attachments for carrying longer or taller materials, trailers having a planar bottom and first and second parallel sides and first and second parallel ends and optionally, with one of the first and second ends being openable as in the form of a tailgate, and so forth. These examples are intended for illustrative purposes only, and not as a limitation on the scope of the present application.

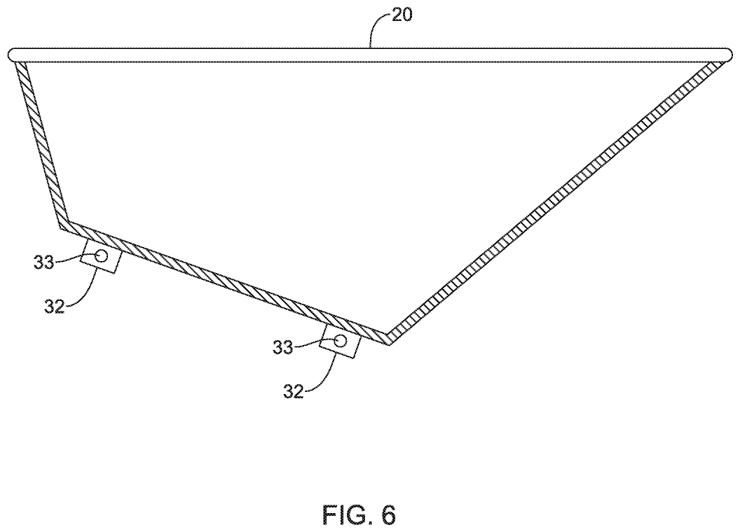

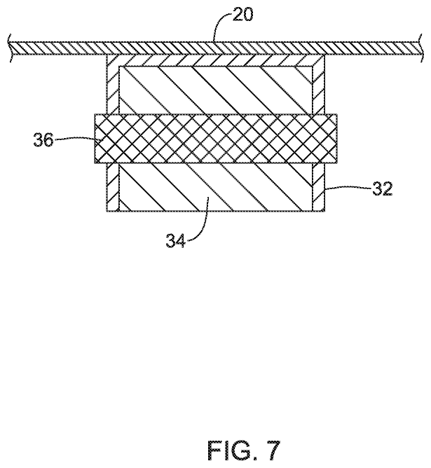

Attachment members or connecting members for attachment of the various utility structures to the frame 12, are discussed in more detail with respect to FIGS. 6 and 7 below.

In this embodiment, handle system 16a includes a first portion 17a, a second portion 17b, and a third portion 17c. The first portion 17a of the handle system 16a is illustrated as extending from and/or away from the base portion 14 of the frame 12, generally toward or closer to a user of the wheelbarrow 10. In this embodiment, the first portion 17a extends above the base portion 14 of the frame 12. The second portion 17b of the handle portion extends from and/or away from the first portion 17a, generally toward or closer to a user of the wheelbarrow 10 than the first portion 17a, and also extends above the first portion 17a of the handle system 16a. The third portion 17c of the handle system 16a also extends from and/or away from the second portion 17b, generally toward or closer to the user of the wheelbarrow 10 than the second portion 17b, and may include, for example, an ergonomic design. In some instances, the third portion 17c, may include, a polymeric or rubberized handle 18 which is, for example, inserted over, molded over, or extruded over, the third portion 17c of the handle system 16a.

The exemplary handle system 16a is not limited to any specific design structure. It can be contemplated by one or ordinary skill in the art that the handle shapes and contours may be altered without deviating from the scope of the present disclosure.

Wheelbarrow 10 further includes at least one front wheel 22, and at least one rear wheel 24. In this example, the wheelbarrow 10 includes a pair of front wheels 22 and a pair of rear wheels 24. More or fewer wheels may be utilized. Front wheels 24 and rear wheels 24 may rotate, swivel or pivot, or both. As used herein, “swivel” or “pivot” may be understood as turning from side to side. In some instances, front wheels 22 rotate (e.g., the front wheels 22 do not swivel) and rear wheels 24 both rotate and swivel. Other arrangements are contemplated where the front wheels 22 can rotate, swivel, or both and/or where the rear wheels 24 can rotate, swivel, or both.

Wheelbarrow 10 also includes a drive mechanism 26 coupled to a lower surface of the base portion 14 of the frame 12. The drive mechanism may be coupled to a throttle system 28, and to the front wheel 22. Drive mechanism 26, may also include an integrated brake system coupled to the handle system 16a (e.g., at the third handle portion 17c), and to the front wheel 22.

The integrated brake system may incorporate cables and/or discs, or a direct pressure method from a lever to the front wheel 22 as is known in the art.

The drive mechanism 26 may include a gas motor with a high torque gear box and drive system. For example, a four cycle gas engine may be employed with horsepower in the range of 1 to 3, or 1.5 to 2.5. In some embodiments, a gear ratio in the range of about 7.0:1.0 to 9.0:1.0 may be employed for the engine. Alternatively, an electric motor or a motor which is a combination of gas and electric (e.g., a hybrid motor), may be employed. In some embodiments, a lithium ion or other suitable battery may be employed to power the drive mechanism 26. These are just examples.

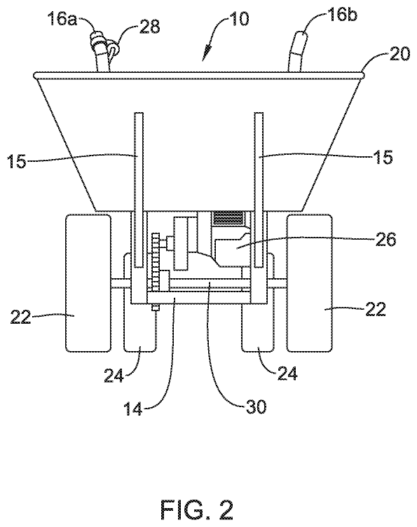

FIG. 2 is a front view of an exemplary wheelbarrow 10. In this embodiment, wheelbarrow 10 includes a first front wheel 22 and a second front wheel 22. The first and second front wheels 22 are disposed and rotate about an axel 30. The first and second front wheels are in communication with and driven by drive mechanism 26. Drive mechanism 26 is further in communication with a throttle system 28, and optionally a brake. Wheelbarrow 10 also includes a first rear wheel 24 and a second rear wheel 24. First and second rear wheels 24 may both rotate and swivel, for example, they may be caster wheels. In this embodiment, the base portion 14 of the frame 12 includes a first support 15 and a second support 15 connected to and further supporting the bucket 20.

Suitably, the first and second front wheels 22 are pneumatic, the first and second rear wheels 24 are pneumatic, or all of the wheels are pneumatic. This embodiment is intended for illustrative purposes only. The wheels may be constructed of any suitable material known in the art without deviating from the scope of this disclosure.

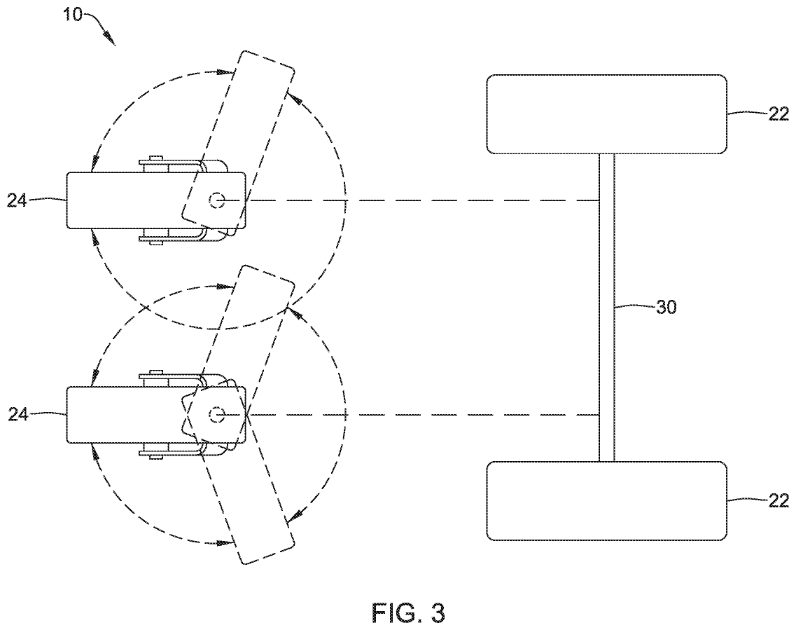

FIG. 3 is a top down view of a portion of an exemplary wheelbarrow 10 illustrating the first and second rear wheels 24, which swivel or pivot from left to right. The first and second front wheels 22 are disposed and rotate about an axel 30.

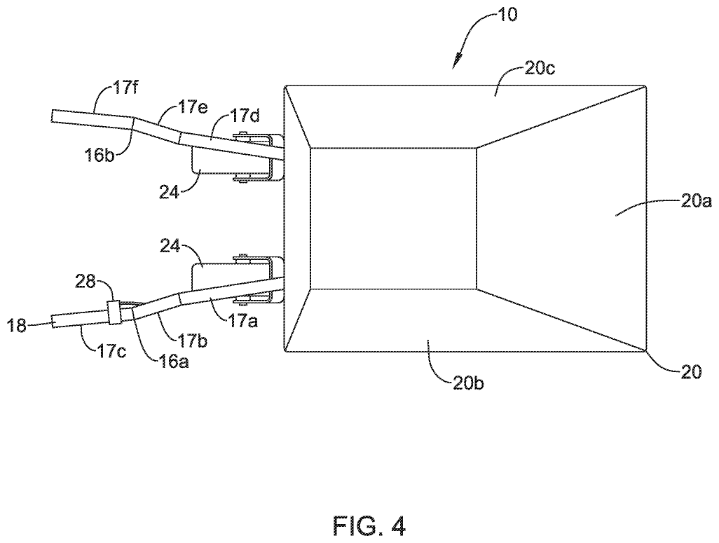

FIG. 4 is a top down view of an exemplary wheelbarrow 10 including a bucket 20. Bucket 20 includes a planar front surface 20a intersecting a first planar side 20b and a second planar side 20c. In at least some instances, the planar front surface 20a of bucket 20 is not contoured or curved. The frame 12 includes a handle region 16. The handle region 16 may include a first handle member 16a and a second handle member 16b. The first handle member 16a may include a first handle portion 17a, which extends from and above the base portion of the frame (not shown), a second handle portion 17b, which extends from and above the first handle portion, and a third handle portion 17c configured for gripping by a user of the wheelbarrow. The second handle member 16b may also include a first handle portion 17d, which extends from and above the base portion of the frame (not shown), a second handle portion 17e, which extends from and above the first handle portion, and a third handle portion 17f configured for gripping by the user of the wheelbarrow 10.

Bucket 20 may be formed from any suitable metal or polymeric material, suitably high density and high strength polymer materials. In some embodiments, the bucket is formed from stainless steel. The gauge of the stainless steel sheet or other suitable material may range from about 22 gauge to about 14 gauge. The bucket 20 suitably has a high payload in the range of about 500 pounds to about 1000 pounds.

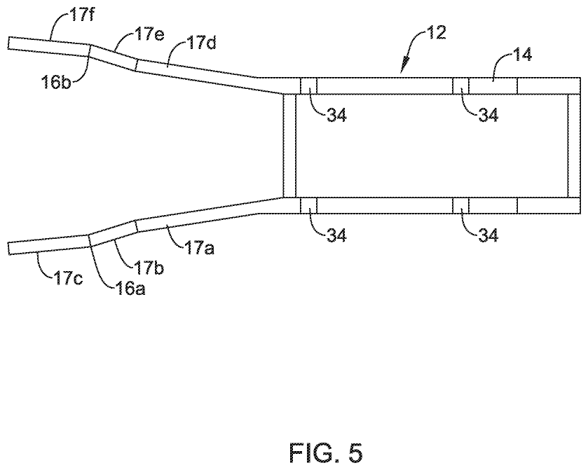

FIG. 5 is a top down view of an exemplary unitary frame 12. Frame 12 includes a base portion 14, a first handle member 16a, and a second handle member 16b. The first handle system 16a includes a first handle portion 17a, which extends from and above the base portion of the frame (not shown), a second handle portion 17b, which extends from and above the first handle portion, and a third handle portion 17c configured for gripping by a user of the wheelbarrow.

The second handle system 16b includes a first handle portion 17d, which extends from and above the base portion of the frame (not shown), a second handle portion 17e, which extends from and above the first handle portion, and a third handle portion 17f configured for gripping by the user of the wheelbarrow 10.

The unitary frame 12 may be formed as a single piece, such as by securing the base portion 14 to the first handle system 16a and the second handle system 16b by a method such as welding, or by molding or extruding it as a single piece.

A connecting member 34 or a plurality thereof, for example, 2, 3, 4 or more connecting members 34 may be secured to or formed as part of the base portion 14 of the frame 12. The connecting member 34 or plurality thereof is explained in more detail below with respect to FIGS. 6 and 7.

Having a unitary frame formed as one piece from a metal, rather than a combination of metal, wood, or plastic, provides additional strength to the frame.

The unitary frame may be formed of any suitable metal, for example, stainless steel. In some embodiments, the frame 12 is formed from square tubing. The gauge of the stainless steel tubing may range from about 16 to about 4, and the tubing may be round or square. In some embodiments, the steel employed may be mild steel, or alloy steel.

FIG. 6 is a side view of an exemplary bucket 20 for a wheelbarrow. In this embodiment, bucket 20 may include one or more exterior mounting regions 32 disposed and secured to a bottom surface of the bucket 20. In this example, the bucket 20 is shown with two exterior mounting regions 32. More or fewer exterior mounting regions 32 may be utilized. Exterior mounting regions 32 may be secured to the bottom surface of the bucket in any suitable way known in the art such as by welding, for example. The exterior mounting regions 32 are configured to receive a connecting member 34 (shown in FIG. 7) therein. The connecting member 34 or plurality thereof is secured to or formed as part of the base portion 14 of the frame 12. The connecting member 34 or plurality thereof may further include a fastening means 36 or locking system as shown in FIG. 7 for insertion into an opening 33 in the mounting region 32. Fastening means may be, for example, a pin, a bolt, and so forth for securing the connecting member 34 to the mounting region 32.

The connecting member 34 or plurality thereof may be optionally configured so as to allow for pivoting points, for example, including a sliding member within the connecting member 34 to allow for the connecting member 34 to rotate off part of the frame, or to become perpendicular to the ground to allow for easier pouring, dumping, offloading, scooping, or otherwise affixing certain materials within the bucket 20, or on or within other utility structures that may be interchanged with the bucket, as discussed with respect to FIG. 1 above. The materials can then be readily transported with the interchangeable motorized utility vehicle assembly, in this embodiment, a wheelbarrow assembly.

In one embodiment, an interior surface of the external mounting region 32 is in the form of a u-channel. The base portion 14 of the frame 12 includes a connecting member 34 which is configured to form a substantially interference fit with the u-channel of the external mounting region 32.

The external mounting region 32 excludes the need for bolts or screws to secure the bucket 20 to the frame 12. Because of this, the bucket 20 may have a smooth, seamless interior surface. This allows for a user to more easily remove, for example using a shovel, rake, hoe, spade, and so forth, the contents of the wheelbarrow 10 as the seamless interior is free from objects that such tools may be caught on or stick to. Thus, in at least some instances, the interior of the bucket 20 is free of fasteners used to secure the bucket 20 to the frame 12.

In other embodiments, a bottom surface of the mounting region 32 may include a channel with a depressible member that fits into the channel (not shown). The depressible member is depressed when the connecting member 34 is inserted into the mounting region 32, and which expands when the connecting member 34 is in place within the mounting region to form a locking system, thereby locking an edge of the connecting member 34 within the connecting member 34. The depressible member can be mechanically depressed to allow the connecting member 34 to be released and removed from the mounting region 32.

The wheelbarrow of the present disclosure provides a variety of benefits including, but not limited to, improved steerability, higher payload, improved durability, improved ease of use, and so forth. The wheelbarrow finds utility for use in construction or landscaping projects that require a more robust utility vehicle.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A motorized wheelbarrow assembly, the assembly comprising:
a unitary frame comprising a base portion and a handle system, the base portion having a first end region and a second end region, the handle system extending from the first end region of the base portion of the frame;
a bucket coupled to the base portion of the frame;
a drive mechanism coupled to a bottom surface of the base portion of the frame;
a first rotatable rear wheel and a second rotatable rear wheel coupled to the first end region of the base portion of the frame; and
a first front wheel and a second front wheel coupled to the second end region of the base portion of the frame and to the drive mechanism, wherein the first front wheel and the second front wheel are driven by the drive mechanism.

2. The motorized wheelbarrow assembly of claim 1, wherein the first rotatable rear wheel, the second rotatable rear wheel, or both are designed to both rotate and swivel.

3. The motorized wheelbarrow assembly of claim 1, wherein the bucket comprises stainless steel.

4. The motorized wheelbarrow assembly of claim 1, wherein the bucket comprises a front planar side intersecting at an angle to a first planar side and to a second planar side.

5. The motorized wheelbarrow assembly of claim 1, wherein the handle system comprises a first handle member and a second handle member.

6. The motorized wheelbarrow assembly of claim 1, wherein a first portion of the handle system, a second portion of the handle system, or both, extend above a base portion of the frame.

7. The motorized wheelbarrow assembly of claim 1, wherein a bottom surface of the bucket comprises a mounting region having an opening, the opening of the mounting region is designed for receiving a connecting member coupled to the base portion of the frame.

8. The motorized wheelbarrow assembly of claim 7, wherein the opening of the mounting region forms an interference fit with the connecting member.

9. The motorized wheelbarrow assembly of claim 7, wherein the mounting region further comprises a fastener for securing the connecting member thereto.

10. The motorized wheelbarrow assembly of claim 7, wherein the mounting region further comprises a locking system for securing the connecting member thereto.

11. The motorized wheelbarrow assembly of claim 1, further comprising an integrated braking system coupled to one or more of the wheels, to the handle system, or both.

12. The motorized wheelbarrow assembly of claim 1, further comprising an integrated throttle system coupled to the drive mechanism, the handle system, or both.

13. The motorized wheelbarrow assembly of claim 1, wherein the drive mechanism comprises a gas engine.

14. The motorized wheelbarrow assembly of claim 1, wherein the drive mechanism comprises a high torque gearbox and drive system.

15. The motorized wheelbarrow assembly of claim 1, wherein the first front wheel, the second front wheel, the first rotatable rear wheel, the second rotatable rear wheel, or a combination thereof comprises a pneumatic tire.

16. The motorized wheelbarrow assembly of claim 1, wherein the frame comprises stainless steel square tubing.

17. A motorized wheelbarrow assembly, the assembly comprising:
a unitary frame comprising a base portion, the base portion having a first end region and a second end region, and a handle extending from the first end region of the base portion of the frame;
a bucket removably coupled to the base portion of the frame;
a drive mechanism coupled to the base portion of the frame;
a first set of one or more wheels coupled to the first end region of the base portion of the frame; and
a second set of one or more wheels coupled to the second end region of the base portion of the frame and to the drive mechanism, wherein the second set of one or more wheels are designed to be driven by the drive mechanism.

18. The motorized wheelbarrow assembly of claim 17, wherein the bucket is replaceable with a single layer planar structure, a multilayer planar structure, an extendable planar structure, or a structure having a planar bottom and first and second parallel sides and first and second parallel ends.

19. The motorized wheelbarrow assembly of claim 17, wherein the second set of one or more wheels are coupled to the second end region of the base portion of the frame, the second set of one or more wheels are rotatable about an axle, the axle is fixed horizontally to the base portion of the frame.

20. A motorized wheelbarrow assembly, the assembly comprising:
a unitary frame comprising a base portion, the base portion having a first end region and a second end region, and a handle extending from the first end region of the base portion of the frame;
a bucket having a seamless interior, the bucket is coupled to the base portion of the frame with an external mounting system, the external mounting system comprising a first portion coupled to a bottom surface of the bucket and a second portion coupled to the base portion of the frame;
a drive mechanism coupled to the base portion of the frame;
a first rotatable caster wheel and a second rotatable caster wheel coupled to the first end region of the base portion of the frame; and
a first front wheel and a second front wheel coupled to the second end region of the base portion of the frame and to the drive mechanism, wherein the first front wheel and the second front wheel are driven by the drive mechanism.
